(19) United States
(12) Patent Application Publication
(10) Pub. No.: US 2006/0191412 A1
(43) Pub. Date: Aug. 31, 2006

(54) Filter service system and method

(75) Inventors: Cheryl L. Sellers, Peoria, IL (US); Dong Fei, Peoria, IL (US); Paul W. Park, Peoria, IL (US); Jill R. Akers, Morton, IL (US); Bappaditya Banerjee, Peoria, IL (US); Mark A. Gasper, Delavan, IL (US); Daniel S. Nordyke, Arlington Heights, IL (US); Richard A. Crandell, Morton, IL (US); Orlando Sellers II, Peoria, IL (US); Christie S. Ragle, Havana, IL (US); Ronald Silver, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/066,996

(22) Filed: Feb. 28, 2005

(51) Int. Cl. B01D 46/00

(52) U.S. Cl. 95/279

(57) ABSTRACT

An on-vehicle service system for removing matter from a filtering device of a single filtering device exhaust system includes a controllable filter bypass line fluidly connecting a first orifice of the filtering device of the single filtering device exhaust system to a second orifice of the filtering device. The service system also includes a receptacle fluidly connected to the filtering device and configured to collect at least a portion of the matter removed by the on-vehicle service system when a fluid is provided through a portion of the filter bypass line into the filtering device.

### TECHNICAL FIELD

The present disclosure relates generally to a filter service system and, more particularly, to a system for removing matter from a filter.

### BACKGROUND

Engines, including diesel engines, gasoline engines, natural gas engines, and other engines known in the art, may exhaust a complex mixture of pollutants. The pollutants may be composed of gaseous and solid material, including particulate matter, nitrogen oxides (“NOx”), and sulfur compounds.

Due to heightened environmental concerns, engine exhaust emission standards have become increasingly stringent over the years. The amount of pollutants emitted from an engine may be regulated depending on the type, size, and/or class of engine. One method that has been implemented by engine manufacturers to comply with the regulation of particulate matter, NOx, and sulfur compounds exhausted to the environment has been to remove these pollutants from the exhaust flow of an engine with filters. However, extended use and repeated regeneration of such filters may cause the pollutants to build up in the components of the filters, thereby causing filter functionality and engine performance to decrease.

One method of removing built-up pollutants from a filter may be to remove the clogged filter from the work machine to which it is connected and direct a flow of gas through the filter in a direction that is opposite the direction of normal flow. The filter may be large, heavy, and difficult to disconnect, however, making it cumbersome, time consuming, and potentially dangerous to remove the filter from the engine of the work machine for such servicing.

Another method of removing matter from a filter may be to divert an exhaust flow from a clogged filter to a separate filter, without disconnecting either filter from the engine. While the exhaust flow is diverted, air may be directed through the clogged filter in a direction opposite the normal flow. Since such matter removal systems include a second filter, however, they may be larger and more costly than single filter systems. Furthermore, such systems may not be capable of applying a negative pressure to the clogged filter to assist in removing the matter.

U.S. Pat. No. 5,566,545 (“the '545 patent”) teaches a system for removing particulate matter from an engine filter. In particular, the '545 patent discloses a first filter and a second filter connected to an engine exhaust line, a valve structure within the exhaust line, and an air feeder for supplying air to the filter in need of service in a reverse direction. When air is supplied to the filter in a reverse flow direction, the air may remove captured particulates from the filter.

Although the '545 patent may teach the removal of matter from a filter using a reversed flow, the system described therein requires the use of a second filter during the reverse flow condition, thereby increasing the overall cost and size of the system. In addition, the system is not capable of supplying a negative pressure to the filter to assist in the filter cleaning process.

The present disclosure is directed to overcoming one or more of the problems set forth above.

### SUMMARY OF THE INVENTION

In one embodiment of the present disclosure, an on-vehicle service system for removing matter from a filtering device of a single filtering device exhaust system includes a controllable filter bypass line fluidly connecting a first orifice of the filtering device of the single filtering device exhaust system to a second orifice of the filtering device. The service system also includes a receptacle fluidly connected to the filtering device and configured to collect at least a portion of the matter removed by the on-vehicle service system when a fluid is provided through a portion of the filter bypass line into the filtering device.

In another embodiment of the present disclosure, an on-vehicle service system for removing matter from a filtering device of a single filtering device exhaust system includes a filter bypass line configured to assist in selectively delivering a flow through the filtering device of the single filtering device exhaust system in a reverse flow direction. The service system also includes a receptacle fluidly connected to the filtering device and configured to collect at least a portion of the matter removed by the on-vehicle service system when the filter bypass line is delivering a flow through the filtering device in the revere flow direction.

In yet another embodiment of the present disclosure, a method of removing matter from a filtering device of a single filtering device exhaust system with an on-vehicle service system includes supplying a flow of fluid to the filtering device of the single filtering device exhaust system in a reverse flow direction, a portion of the flow passing through a filter bypass line. The method also includes capturing at least a portion of the matter removed from the filtering device within a receptacle of the on-vehicle service system when the portion of the flow passes through the filter bypass line.

In still another embodiment of the present disclosure, an engine system of a work machine includes an engine having an exhaust outlet and a single filtering device for receiving an exhaust flow from the exhaust outlet of the engine. The filtering system further includes an on-vehicle service system for removing matter from the single filtering device. The on-vehicle service system includes a controllable filter bypass line fluidly connecting a first orifice of the single filtering device to a second orifice of the filtering device. The on-vehicle service system also includes a receptacle fluidly connected to the single filtering device and configured to collect at least a portion of the matter removed from the single filtering device.

### BRIEF DESCRIPTION OF THE DRAWINGS

FIG. 1 is a diagrammatic illustration of a service system connected to a filter according to an exemplary embodiment of the present disclosure.

FIG. 2 is a diagrammatic illustration of a service system connected to a filter according to another exemplary embodiment of the present disclosure.

FIG. 3 is a diagrammatic illustration of a service system connected to a filter according to yet another exemplary embodiment of the present disclosure.

### DETAILED DESCRIPTION

Exemplary embodiments of the present disclosure are illustrated in the accompanying drawings. Wherever possible, the same reference numbers will be used throughout the drawings to refer to the same or like parts.

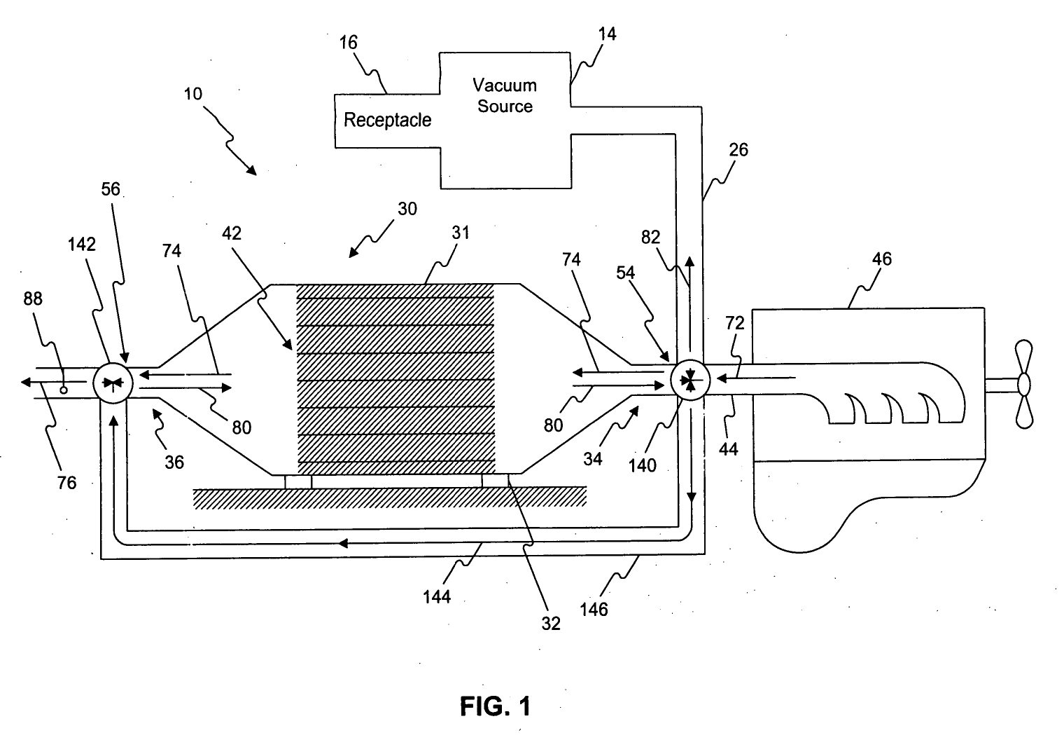

FIG. 1 illustrates an exemplary embodiment of a service system 10 attached to a filter 30. The service system 10 may include a bypass line 146, a receptacle 16 fluidly connected to the filter 30, and a vacuum source 14 fluidly connected to the filter 30. It is understood that in an embodiment of the present disclosure, the vacuum source 14 may be omitted. The service system 10 may remain connected to the filter 30 for servicing, and a user may operate the service system 10 without removing the filter 30 from the work machine.

In an embodiment of the present disclosure, the filter 30 may be connected to an internal combustion engine 46, such as, for example, a diesel engine. The engine 46 may include an exhaust line 44 connecting an exhaust flow of the engine 46 with an inlet 34 of the filter 30. The engine 46 may also include a turbo (not shown) connected to the exhaust line 44. In such an embodiment, the inlet 34 of the filter 30 may be connected to an outlet of the turbo.

An inlet valve 140 may be disposed at a first orifice 54 of the filter 30. In an exemplary embodiment of the present disclosure, the first orifice 54 may be an inlet 34 of the filter 30. In such an embodiment, the inlet valve 140 may be disposed between the exhaust line 44 of the engine 46 and the inlet 34 of the filter 30. The inlet valve 140 may be configured to allow an exhaust flow of the engine 46 to pass into the filter 30 while blocking the exhaust flow from passing to, for example, the bypass line 146 and/or other components of the service system 10. The inlet valve 140 may also be configured to block communication between the engine 46 and the filter 30 at the first orifice 54. Such a configuration may be advantageous during, for example, servicing of the filter 30. For example, while the filter 30 is being serviced, the inlet valve 140 may prohibit captured material from flowing back to the engine 46 through the inlet 34. As will be described in greater detail below, in such an embodiment, the inlet valve 140 may also assist in directing the flow and/or the captured material to, for example, the receptacle 16. It is understood that the engine 46 may remain running during servicing and may produce the exhaust flow used to remove matter from the filter 30. The inlet valve 140 may be controlled and/or actuated by any means known in the art, such as, for example, a solenoid or pneumatics. Alternatively, the inlet valve 140 may be manually controlled.

The filter 30 may further include an outlet valve 142 disposed proximate a second orifice 56 of the filter 30. In an exemplary embodiment of the present disclosure, the second orifice 56 may be an outlet 36 of the filter 30. In such an embodiment, the outlet valve 142 may be disposed at the outlet 36. Outlet valve 142 and inlet valve 140 may be the same type of valve or may be different types of valves, depending on the requirements of the application. The valves 140, 142 may be, for example, one-way valves, two-way valves, three-way valves, or any other type of controllable flow valves known in the art. For example, the valves 140, 142 may be controlled to allow any range of exhaust flow to pass from the engine 46 to the filter 30 and out of the filter 30. The valves 140, 142 may also be configured to allow any range of exhaust flow to pass from the engine 46 to the bypass line 146 and into the filter 30 in a reverse flow direction. It is understood that the service systems described herein may include any combination of valves and/or bypass lines useful in supplying a flow to the filter 30 in a desired manner. For example, a plurality of one-way valves may be used in place of the two-way and/or three-way valves described above to achieve a desired flow path. As mentioned above, it is also understood that the valves 140, 142 may be configured to assist in-directing the flow and/or matter removed from the filter 30 to, for example, the receptacle 16.

In some embodiments, one or more work machine diagnostic devices 88 may be disposed proximate the second orifice 56 of the filter 30. The work machine diagnostic devices 88 may be, for example, part of the work machine or other device to which the filter 30 is connected and may be external to the filter 30. Alternatively, the work machine diagnostic devices 88 may be internal to the filter 30. Work machine diagnostic devices 88 may be any sensing devices known in the art, such as, for example, flow meters, emission meters, pressure transducers, radio devices, or other sensors. Such work machine diagnostic devices 88 may sense, for example, an increase in the levels of soot, NOx, or other pollutants leaving the filter 30. The work machine diagnostic devices 88 may send pollutant level information to a controller or other device (not shown) and may assist in, for example, triggering filter regeneration and/or filter servicing.

As shown in FIG. 1, the bypass line 146 may fluidly connect the first orifice 54 to the second orifice 56. The bypass line 146 may be any type of tubing, piping, or hose known in the art. The bypass line 146 may be, for example, plastic, rubber, aluminum, copper, steel, or any other material capable of delivering an exhaust flow, a compressed gas, and/or any other type of fluid flow in a controlled manner, and may be flexible or rigid. The length of the bypass line 146 may be minimized to facilitate operation of the service system 10, while reducing the pressure drop between, for example, the engine 46 and the filter 30. The bypass line 146 may be configured to assist in delivering a flow through the filter 30 in a reverse flow direction and may direct a flow from, for example, the inlet 34 of the filter 30 to the outlet 36. As explained above, the inlet and outlet valves 140, 142 may be configured to assist in directing the flow through the bypass line 146.

The filter 30 may be any type of filter known in the art, such as, for example, a foam cordierite, sintered metal, or silicon carbide type filter. As illustrated in FIG. 1, the filter 30 may include filter media 42. The filter media 42 may include any material useful in removing pollutants from an exhaust flow. In some embodiments of the present disclosure, the filter media 42 may contain catalyst materials capable of collecting, for example, soot, NOx, sulfur compounds, particulate matter, and/or other pollutants known in the art. Such catalyst materials may include, for example, alumina, platinum, rhodium, barium, cerium, and/or alkali metals, alkaline-earth metals, rare-earth metals, or combinations thereof. The filter media 42 may be situated horizontally (as shown in FIG. 1), vertically, radially, or helically. The filter media 42 may also be situated in a honeycomb, mesh, or any other configuration so as to maximize the surface area available for the filtering of pollutants.

The filter 30 includes a filter housing 31 and may be secured by any means known in the art. The filter 30 may include, for example, filter brackets 32 connected to the filter housing 31. Filter brackets 32 may be made of metal, plastic, rubber, or any other material known in the art to facilitate connecting a filter to a structure associated with the engine 46. For example, filter brackets 32 may secure the filter 30 to a work machine and may dampen the filter 30 from vibration, jarring, or sudden movements of the work machine to which the filter 30 is attached.

As shown in FIG. 1, a matter removal line 26 may fluidly connect the filter 30 to, for example, the vacuum source 14. Alternatively, in an exemplary embodiment in which the service system 10 does not include a vacuum source 14, the matter removal line 26 may fluidly connect the filter 30 to the receptacle 16. Such fluid connections may allow a solid, liquid, or gas to pass from the filter 30 through, for example, the first orifice 54. It is understood that the fluid connection may permit soot, ash, or other matter removed from the filter media 42 to pass from the filter 30 to the receptacle 16 and/or the vacuum source 14. The matter removal line 26 may be any type of vacuum line known in the art and may have mechanical characteristics similar to those of bypass line 146. The matter removal line 26 may be as short as possible to facilitate operation of the service system 10 and to reduce the pressure drop between, for example, the vacuum source 14 and the filter 30. The matter removal line 26 may be attached to the first orifice 54 of the filter 30 by any conventional means. As described above, the inlet valve 140 may be configured to direct and/or otherwise control a flow through the matter removal line 26 during operation of the work machine and during filter servicing.

The receptacle 16 of the service system 10 may be configured to collect matter removed from the filter 30. The receptacle 16 may be any size useful in collecting the matter removed from the filter 30 and may have any useful capacity and shape. For example, the receptacle 16 may be cylindrical or box shaped, and may be a rigid container or a flexible bag. The receptacle 16 may be designed to collect and store matter of any type or composition. In one embodiment of the present disclosure, the receptacle 16 may be designed to store harmful pollutants, such as, for example, ash, and may be made of, for example, steel, tin, reinforced cloth, aluminum, composites, ceramics, or any other material known in the art. The receptacle 16 may be rapidly disconnected and reconnected to the matter removal line 26 and/or the vacuum source 14 to facilitate disposal of the matter collected therein.

As shown in FIG. 1, a vacuum source 14 of the service system 10 may be fluidly connected to the receptacle 16. For example, in an embodiment, the vacuum source 14 may draw matter from the filter 30, the removed matter may pass through a vacuum filter internal to the vacuum source (not shown), and the receptacle 16 may collect and store the matter collected by the vacuum filter. The vacuum source 14 may include, for example, a shop vacuum, a vacuum pump, or any other device capable of creating negative pressure within another device. The vacuum source 14 may be of any power or capacity useful in cleaning the filter 30, and its size may be limited by the size and/or type of filter 30 being cleaned. For example, a filter 30 including cordierite plugs may not be capable of withstanding a negative pressure of greater than approximately 150 psi without sustaining damage to the plugs and/or other filter media 42. Thus, a vacuum source 14 used to clean such a filter 30 may have a maximum capacity that is less than approximately 150 psi. In some embodiments of the present disclosure, the vacuum source 14 may supply a constant vacuum to, and thereby create a constant negative pressure within, the filter 30. Alternatively, the vacuum source 14 may supply a pulsed or varying vacuum to the filter 30. The consistency of the vacuum supplied to the filter 30 may vary with each application and may depend on the structure, design, type, and/or other characteristics of the filter 30.

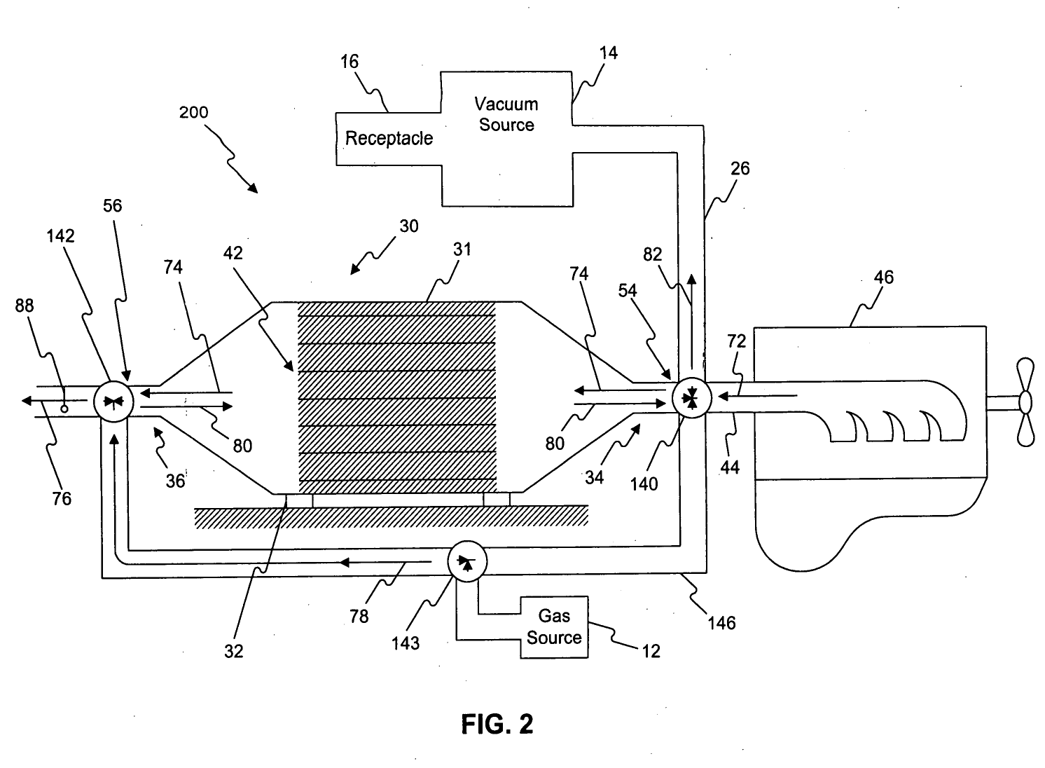

FIG. 2 illustrates another exemplary embodiment of an on-vehicle service system 200 attached to a filter 30. The service system 200 may include a bypass line 146 and a receptacle 16 fluidly connected to a filter 30. The service system 200 may further include a gas source 12 configured to provide a flow to the second orifice 56 of the filter 30, and a vacuum source 14 fluidly connected to the filter 30. As described above with respect to the service system 10, the service system 200 may be operatively connected to the filter 30 during operation of the work machine and may remain connected to the filter 30 for service. As such, a user may operate the service system 200 without removing the filter 30 from the work machine, vehicle, or other device to which the filter 30 is attached.

As shown in FIG. 2, the gas source 12 of the service system 200 may be fluidly connected to bypass line 146 by, for example, a gas source valve 143. The gas source valve 143 may allow an exhaust flow from the engine 46 to pass through the bypass line 146 while prohibiting a flow to pass between the bypass line 146 and the gas source 12. Alternatively, as illustrated in FIG. 2, the gas source valve 143 may permit a flow to pass through the bypass line 146 from the gas source 12 to the outlet valve 142. In this configuration, the gas source valve 143 may prohibit the flow from passing through the bypass line 146 in the direction of the inlet valve 140. The gas source valve 143 may be a two-way valve and may have the same mechanical characteristics as, for example, the outlet valve 142. In an exemplary embodiment of the present disclosure, the gas source valve 143 may be the same as the outlet valve 142.

It is understood that the gas source 12 may be fluidly connected to the filter 30 in any way, and at any location, so as to be capable of providing a flow to the filter 30 in a reverse flow direction. The gas source 12 may include, for example, an air compressor or any other device capable of compressing a gas and delivering the compressed gas to the filter 30. For example, in one embodiment of the present disclosure, the gas source 12 may be a shop air compressor of a type known in the art and may supply compressed air at approximately 70 to 110 psi. This range may be increased or decreased depending on the size of the gas source 12 used. The gas source 12 may deliver a gas in either a pulsed flow, a uniform flow, or some combination thereof. The gas may be any gas known in the art useful in removing ash or other matter from a filter, such as, for example, air, oxygen, hydrogen, nitrogen, or helium. It is understood that the gas may be capable of being compressed by the gas source 12 and delivered through the bypass line 146 to the outlet 36 of the filter 30.

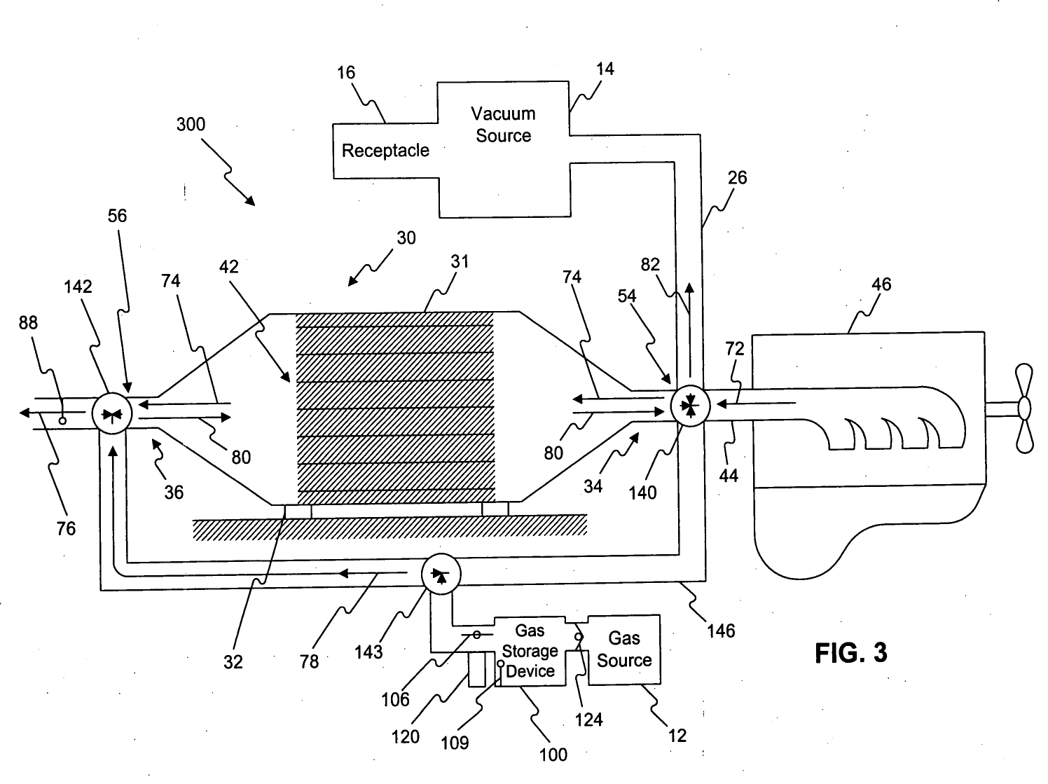

As shown in FIG. 3, a service system 300 of the present disclosure may further include a gas storage device 100. The gas storage device 100 may be located, for example, downstream of the gas source 12, and an outlet of the gas source 12 may be fluidly connected to a gas storage device inlet. The gas storage device 100 may be any device capable of storing a pressurized gas. The gas storage device 100 may include, for example, a high pressure gas tank or an expandable storage container. The gas storage device 100 may be made of any material known in the art and may be rigid or flexible. Such materials may include, for example, steel, cast iron, copper, aluminum, titanium, platinum, and/or any alloys or combinations thereof In addition, the gas storage device 100 may also be made from plastic, rubber, vinyl, polytetrafloroethylene, expanded polytetrafloroethylene, or some derivative or combination thereof. In yet another alternative, the gas storage device 100 may be made from a combination of any of the metals and/or nonmetals described above.

The gas storage device 100 mats have any capacity useful in supplying a controlled volume of high pressure gas to a device, such as, for example, a filter. The gas storage device 100 may be capable of storing gas at any desirable pressure relative to atmosphere. For example, in one embodiment of the present disclosure, the gas storage device 100 may be capable of storing pressurized gas in a range that may be safe for servicing filters containing, for example, cordierite plugs. As previously discussed, such plugs, and other like filter media 42, may not be capable of withstanding a pressure of greater than approximately 150 psi without sustaining damage.

The gas storage device 100 may include at least one gas storage device sensor 109 capable of sensing, for example, flow, pressure, temperature, or other flow metrics known in the art. The couplings or other means used to fluidly connect the gas storage device 100 to, for example, the gas source 12 may be sized and otherwise designed to form a sealed connection, regardless of the gas pressure within the gas storage device 100. The wall thickness of the gas storage device 100 may also be appropriate for such pressures. In addition, the gas storage device 100 may be advantageously shaped to store and controllably release a desired volume of pressurized gas. For example, the gas storage device 100 may be cylindrical or spherical to maximize structural integrity.

A gas storage device valve 106 may be disposed proximate an outlet of the gas storage device 100. The gas storage device valve 106 may be, for example, a poppet valve, butterfly valve, controllable membrane, or any other type of controllable flow regulation device known in the art. For example, the gas storage device valve 106 may be controlled to allow any range of gas to pass from the gas source 12 to the filter 30. The gas storage device valve 106 may be positioned to completely restrict a flow of gas from the gas source 12 or may allow the flow to pass unrestricted. The gas storage device valve 106 may be connected to the gas storage device 100 by any conventional means known in the art. In some embodiments, the gas storage device valve 106 may be controlled to fully open and/or fully close at-relatively high speeds. This high speed movement may be facilitated by a high speed control mechanism 120. The high speed control mechanism 120 may include, for example, an electric, piezoelectric, pneumatic, hydraulic, or other controller. In some embodiments, the high speed control mechanism 120 may be a solenoid, servo motor, or other conventional means.

The gas storage device 100 may also include a check valve 124. The check valve 124 may be disposed, for example, proximate an inlet of the gas storage device 100 or within the bypass line 146 between the gas source 12 and the gas storage device 100. The check valve 124 may be configured to permit compressed gas to flow into the gas storage device 100 from the gas source 12 and to prohibit gas from exiting through the gas storage device inlet. The check valve 124 may, thus, assist in the storage of pressurized gas within the gas storage device 100.

It is understood that in further exemplary embodiments of the present disclosure, various other flow paths, bypass lines, valve configurations, and/or other service system components may be used to direct a flow through the filtering device 30. The operation of the exemplary embodiments of the service systems 10, 200, 300 described above will now be discussed in greater detail.

### INDUSTRIAL APPLICABILITY

The service system components, configurations, and flow paths described herein may enable a user to bypass components of an exhaust system of a work machine and direct a flow through a filter in a reverse flow direction. The service systems 10, 200, 300 of the present disclosure may assist in removing matter from single filtering device exhaust systems. Such exhaust systems may only have one filter or other filtering device dedicated to removing, for example, soot and other harmful particulates and/or pollutants from an engine exhaust flow. In addition, each of the service systems 10, 200, 300 disclosed herein may be on-vehicle systems. As used herein, the term “on-vehicle” means a system in which each component of the system remains connected to a work machine during operation of the work machine. For example, an on-vehicle service system may be operatively connected to a filter, and the components of the system may be mounted and/or otherwise connected to the work machine, vehicle, or other device to which the filter is attached, during operation of the work machine as well as during filter servicing. Such on-vehicle service systems may be fixedly secured within a compartment of the work machine, such as the engine compartment. In addition, as discussed above the filter 30 may include additional upstream devices, such as, for example, catalysts and/or work machine diagnostic devices 88, within the filter housing 31. These additional upstream devices may be moved and/or removed to allow access to the filter media 42 for servicing in an on-vehicle system 10, 200, 300. As used herein, the term “work machine” may include on-road vehicles, off-road vehicles, and stationary machines, such as, for example, generators and/or other exhaust producing devices.

The disclosed service systems 10, 200, 300 may be used with any filter 30, filtering device, or other matter collection device known in the art. Such devices may be used in any application where the removal of matter is desired. For example, such devices may be used on diesel, gasoline, natural gas, or other combustion engines or furnaces known in the art.

A variety of different methods and systems may be used to remove matter from the filtering-devices of work machines. For example, some filters used in such machines may be cleaned through regeneration. During regeneration, a heater or some other heat source may be used to increase the temperature of the filter components. The heater may also increase the temperature of trapped particulate matter above its combustion temperature, thereby burning away the collected particulate matter and regenerating the filter while leaving behind a small amount of ash. Although regeneration may reduce the buildup of particulate matter in the filter, repeated regeneration of the filter may result in a buildup of ash in the components of the filter over time and a corresponding deterioration in filter performance. Unlike particulate matter, ash cannot be burned away through regeneration. Thus, in some situations, it may be necessary to remove built-up ash from an engine filter using other techniques and systems.

As illustrated by exhaust flow arrow 72 in FIG. 1, in a normal operating condition for the engine 46, an exhaust flow may exit the engine 46 through the exhaust line 44 and may pass through the inlet valve 140 of the filter 30. The inlet valve 140 may be manipulated and/or otherwise controlled to facilitate passage of the exhaust flow from the engine 46 into the filter 30. The inlet valve 140 may also prohibit passage of the exhaust flow through the bypass line 146 and the matter removal line 26 during the normal operation condition. The exhaust flow may enter the filter 30 through the inlet 34 and may travel across at least a portion of the filter media 42, as illustrated by process flow arrows 74. Upon exiting the filter 30 via the outlet 36, the exhaust flow may pass through outlet valve 142, as shown by the filtered flow arrow 76.

Over time, the work machine diagnostic devices 88 may sense an increase in the amount of pollutants being released to the atmosphere. Based on these readings, the filter 30 may undergo regeneration either automatically or as a result of some operator input. As described above, after a number of regeneration cycles, ash may begin to build up in the filter media 42. The service system 10 of the present disclosure may then be activated to assist in removing the ash collected therein. It is understood that the system 10 may also be used to assist in the removal of soot and/or other matter collected within the filter 30.

To begin the removal of ash from the filter 30, the inlet valve 140 may be manipulated and/or otherwise controlled to direct the exhaust flow from the engine 46 to the bypass line 146. It is understood that in the embodiment illustrated in FIG. 1, the engine 46 may remain running during filter servicing, and the exhaust flow produced during combustion may be used to assist in removing matter from the filter 30. As illustrated by exhaust flow arrow 144, the bypass line 146 may direct the exhaust flow to the outlet 36 of the filter 30. The exhaust flow may then be directed through the outlet valve 142 and into the filter 30. The outlet valve 142 may be manipulated and/or otherwise controlled to direct the exhaust flow from the engine 46 into the filter 30 through the outlet 36. In this configuration, the outlet valve 142 may prohibit the exhaust flow from passing in the direction of filtered flow arrow 76 during servicing. The inlet and outlet valves 140, 142 may be manually manipulated and/or controlled by the user. Alternatively, in an embodiment where the valves 140, 142 may be actuated by, for example, a solenoid, hydraulic, electric, or pneumatic means, or other means, the valves 140, 142 may be controlled remotely. Controlling inlet valve 140 in this manner may protect components of the engine 46 during the ash removal process and may prevent ash from entering the engine 46 through exhaust line 44.

The exhaust flow may pass through the filter 30 in the direction of reverse flow arrows 80. While in this reverse flow condition, ash and other matter trapped within the filter media 42 may be broken free and carried with the reverse flow toward the inlet 34. Once ash is broken free, it may be carried out of the filter 30, through the receptacle line 26, and into the receptacle 16 and/or the vacuum source 14, as shown by receptacle flow arrow 82. The ash may be safely stored in the receptacle 16 throughout the ash removal process and may reside in the receptacle 16 until disposed of.

In an embodiment where the service system 10 includes a vacuum source 14, the vacuum source 14 may supply a vacuum or negative pressure to the filter 30 while the exhaust flow passes through the filter 30 in the direction of reverse flow arrows 80. The vacuum source 14 may, thus, assist in pulling a flow through the filter 30 in a direction opposite the direction of exhaust flow during normal filter operating conditions. The vacuum supplied by the vacuum source 14 may improve the ash removal capabilities of the service system 10 and may be useful in removing ash lodged deep within the filter media 42 of the filter 30.

The user may determine whether the filter 30 is substantially free of ash by using existing work machine diagnostic devices 88, or other means known in the art. For example, after directing a reversed flow through the filter 30, the user may control the inlet and outlet valves 140, 142 to allow an exhaust flow to pass from the inlet 34 of the filter 30 to the outlet 36 in the direction of process flow arrow 74. Work machine diagnostic devices 88 downstream of the filter 30 may determine whether the filter 30 is operating under substantially ash-free conditions or whether the filter 30 requires further service.

In an exemplary embodiment of the present disclosure in which the service system 200 further includes a gas source 12 fluidly connected to the bypass line 146 by a gas source valve 143, the user may begin to service the filter. 30 by controlling the inlet valve 140 to divert the exhaust flow from the engine 46 to the bypass line 146. In this configuration, the inlet valve 140 may substantially prohibit any flow from passing into the filter 30 through the inlet 34. The user may also activate the gas source 12. The gas source valve 143 may be controlled to permit the exhaust flow of the engine and a compressed gas flow from the gas source 12 to pass through the bypass line 146 to the outlet valve 142. Such a flow is illustrated by compressed flow arrow 78. The outlet valve 142 may be controlled to direct the flow from the bypass line 146 into the filter 30 in the direction of reverse flow arrow 80.

Alternatively, the engine 46 may be turned off during servicing such that combustion ceases and no exhaust flow is produced. In this embodiment, the gas source valve 143 may be controlled to permit a flow of compressed gas to pass through the bypass line 146 from the gas source 12 to the outlet valve 142. In such an embodiment, the gas source valve 143 may also be controlled to prohibit a flow from passing through the bypass line 146 in the direction of the inlet valve 140.

In embodiments where the service system 200 includes a vacuum source 14, the volume of compressed gas supplied by the gas source 12 may substantially coincide with the volume of gas removed by the vacuum source 14. In other embodiments, however, the output of the gas source 12 may not be related to the input of the vacuum source 14. It is understood that in embodiments where the input of the vacuum source 14 and the output of the gas source 12 are not calibrated to be substantially equivalent, the overall efficiency of the service system 200 may not be maximized.

As shown in FIG. 3, in an embodiment where the service system 300 further includes a gas storage device 100, the gas storage device valve 106 may be closed while the gas source 12 is activated. Closing the gas storage device valve 106 may allow for at least a portion of the flow of compressed gas to be stored within the gas storage device 100. Pressure may increase within the gas storage device 100 as the portion of the flow is stored therein. The check valve 124 may prevent pressurized gas from exiting through the gas storage device inlet and may thus, assist in storing gas at a positive pressure.

As described above with respect to FIG. 2, to begin servicing the filter 30, the user may control the inlet valve 140 to divert the exhaust flow from the engine 46 to the bypass line 146. The inlet valve 140 may substantially prohibit any flow from passing into the filter 30 through the inlet 34. The user may also activate the gas source 12 while the gas storage device valve 106 is closed. The gas source valve 143 may be controlled to permit the exhaust flow of the engine 46 to pass through the bypass line 146 to the outlet valve 142. Once a desired pressure within the gas storage device 100 has been reached, the gas storage device valve 106 may be opened and the stored gas may be released. The gas source valve 143 may be controlled to permit the flow of stored gas to pass to the bypass line 146 in the direction of the outlet valve 142. It is understood that the gas source valve 143 may also prohibit the flow of stored gas from passing through the bypass line 146 in the direction of the inlet valve 140. The outlet valve 142 may be controlled to direct the flow from the bypass line 146 into the filter 30 in the direction of reverse flow arrow 80.

The gas storage device valve 106 may be opened rapidly to maximize the force with which the stored gas is released from the gas storage device 100. The released gas may create a shockwave of compressed gas across the filter media 42 and may improve the matter removal capabilities of the system 300. For instance, a shockwave of gas may be capable of removing matter deep within the filter media 42 in less time and with less effort than a system where a shockwave is not utilized. As described above, the stored flow of gas may be supplied in a direction opposite from the direction of normal flow through the filter 30. It is understood that in embodiments in which the service system 300 includes a vacuum source 14, the vacuum source 14 may be activated before, or at substantially the same time, the gas storage device valve 106 is opened.

Alternatively, as described above the engine 46 may be turned off during servicing such that combustion ceases and no exhaust flow is produced. In this embodiment, the gas source valve 143 may be controlled to permit a flow of compressed gas to pass through the bypass line 146 from the gas storage device 100 to the outlet valve 142. In such an embodiment, the gas source valve 143 may also be controlled to prohibit a flow from passing through the bypass line 146 in the direction of the inlet valve 140.

Other embodiments of the disclosed service system 10 will be apparent to those skilled in the art from consideration of the specification. For example, the filter 30 may be fitted with at least one boss to facilitate insertion of a flow distribution device and/or a flow receiving device into the filter 30. The flow distribution device may be, for example, a nozzle and the flow receiving device may be, for example, a pipe or vacuum tube. Furthermore, the gas source 12 and the vacuum source 14 may be the same device.

Moreover, the service systems 10, 200, 300 may include at least one sensor for sensing a characteristic of a flow through the filter 30. The sensor may be connected to a service system controller. The controller may control aspects of the ash removal process in response to signals received from the at least one sensor. To facilitate this control, the inlet and outlet valves 140, 142, the gas source 12, and/or the vacuum source 14 may be controllably connected to the controller. It is intended that the specification and examples be considered as exemplary only, with the true scope of the invention being indicated by the following claims.

What is claimed is:

1. An on-vehicle service system for removing matter from a filtering device of a single filtering device exhaust system, the service system comprising:
a controllable filter bypass line fluidly connecting a first orifice of the filtering device of the single filtering device exhaust system to a second orifice of the filtering device; and
a receptacle fluidly connected to the filtering device and configured to collect at least a portion of the matter removed by the on-vehicle service system when a fluid is provided through a portion of the filter bypass line into the filtering device.

2. The service system of claim 1, wherein the service system is fixedly attached to the filtering device and is configured to remove matter from the filtering device while the filtering device is connected to a work machine.

3. The service system of claim 1, wherein the filter bypass line is configured to direct an exhaust flow to the second orifice.

4. The service system of claim 1, wherein the first orifice is an inlet of the filtering device and the second orifice is an outlet of the filtering device.

5. The service system of claim 1, further including a first valve disposed proximate the first orifice of the filtering device and a second valve disposed proximate the second orifice of the filtering device.

6. The service system of claim 5, wherein the first valve is configured to direct an exhaust flow through at least a portion of the filter bypass line.

7. The service system of claim 5, wherein the first valve is configured to direct a flow from the filtering device to the receptacle.

8. The service system of claim 5, wherein the second valve is configured to direct a flow through the filtering device in a reverse flow direction.

9. The service system of claim 1, further including a vacuum source fluidly connected to the receptacle and configured to assist in removing matter from the exhaust system.

10. The service system of claim 9, wherein the vacuum source includes a vacuum pump.

11. The service system of claim 1, further including a gas source configured to direct a flow of fluid to the second orifice of the filtering device.

12. The service system of claim 11, wherein the gas source is fluidly connected to the filter bypass line.

13. The service system of claim 11, wherein the gas source includes a compressor.

14. The service system of claim 11, further including a gas storage device fluidly connected to the gas source, the gas storage device being controllably fluidly connectable to the second orifice of the filtering device.

15. The service system of claim 14, further including a valve disposed between the gas storage device and the filtering device, wherein the valve is controlled by an electrically controlled actuator.

16. The service system of claim 15, wherein the electrically controlled actuator comprises a piezoelectric material.

17. The service system of claim 14, further including at least one sensor configured to sense at least one of pressure, flow, or temperature within the gas storage device.

18. The service system of claim 1, wherein the filtering device is a particulate filter.

19. An on-vehicle service system for removing matter from a filtering device of a single filtering device exhaust system, comprising:
a filter bypass line configured to assist in selectively delivering a flow through the filtering device of the single filtering device exhaust system in a reverse flow direction; and
a receptacle fluidly connected to the filtering device and configured to collect at least a portion of the matter removed by the on-vehicle service system when the filter bypass line is delivering a flow through the filtering device in the reverse flow direction.

20. The service system of claim 19, wherein the service system is fixedly attached to the filtering device and is configured to remove matter from the filtering device while the filtering device is connected to a work machine.

21. The service system of claim 19, wherein the filter bypass line is configured to direct an exhaust flow from an inlet of the filtering device to an outlet of the filtering device.

22. The service system of claim 21, further including a first valve disposed proximate the inlet of the filtering device and a second valve disposed proximate the outlet of the filtering device.

23. The service system of claim 19, further including a vacuum source fluidly connected to the receptacle and configured to assist in removing matter from the exhaust system.

24. The service system of claim 19, further including at least one of a gas source and a gas storage device configured to assist in delivering a flow through the filtering device.

25. A method of removing matter from a filtering device of a single filtering device exhaust system with an on-vehicle service system, comprising:
supplying a flow of fluid to the filtering device of the single filtering device exhaust system in a reverse flow direction, a portion of the flow passing through a filter bypass line; and
capturing at least a portion of the matter removed from the filtering device within a receptacle of the on-vehicle service system when the portion of the flow passes through the filter bypass line.

26. The method of claim 25, further including delivering a negative pressure to at least a portion of the filtering device.

27. The method of claim 25, further including diverting the flow from an inlet of the filtering device to an outlet of the filtering device during operation of the exhaust system.

28. The method of claim 25, further including delivering a flow of compressed gas to at least a portion of the filtering device with a gas source.

29. An engine system of a work machine, comprising:
an engine having an exhaust outlet;
a single filtering device for receiving an exhaust flow from the exhaust outlet of the engine; and
an on-vehicle service system for removing matter from the single filtering device, the on-vehicle service system including
a controllable filter bypass line fluidly connecting a first orifice of the single filtering device to a second orifice of the filtering device, and
a receptacle fluidly connected to the single filtering device and configured to collect at least a portion of the matter removed from the single filtering device.

30. The filtering system of claim 29, wherein on-vehicle service system further includes a vacuum source fluidly connected to the receptacle and configured to assist in removing matter from the single filtering device.

31. The filtering system of claim 29, wherein the vehicle service system further includes a gas source configured to direct a flow of fluid to the second orifice of the filtering device.

32. The filtering system of claim 31, wherein the vehicle service system further includes a gas storage device fluidly connected to the gas source, the gas storage device being controllably fluidly connectable to the second orifice of the filtering device.

33. The filtering system of claim 29, wherein the vehicle service system further includes a first valve disposed proximate the first orifice of the single filtering device and a second valve disposed proximate the second orifice of the single filtering device.
